(19) United States
(12) Patent Application Publication
(10) Pub. No.: US 2015/0116190 A1
(43) Pub. Date: Apr. 30, 2015

(54) DISPLAY DEVICE

(71) Applicant: Kabushiki Kaisha Toshiba, Minato-ku (JP)

(72) Inventors: Takashi SASAKI, Yokohama (JP); Haruhiko OKUMURA, Fujisawa (JP); Aira HOTTA, Kawasaki (JP); Akihisa MORIYA, Kawasaki (JP); Akira KINNO, Yokohama (JP); Masahiro BABA, Yokohama (JP)

(73) Assignee: Kabushiki Kaisha Toshiba, Minato-ku (JP)

(21) Appl. No.: 14/458,463

(22) Filed: Aug. 13, 2014

(30) Foreign Application Priority Data
Oct. 25, 2013 (JP) 2013-222642

(51) Int. Cl. G09G 3/00; G09G 3/34; G02B 27/01

(52) U.S. Cl. CPC G09G 3/002; G02B 27/0101; G09G 3/3406; G02B 2027/014; G02B 2027/0138
USPC 345/7

(57) ABSTRACT

According to one embodiment, a display device includes a light emitting unit, a reflective unit, a sensor, and a controller. The light source emits light including an image information relating to operation to be performed by an operator. The reflector reflects at least a part of the light emitted from the light source toward an eye of the operator and transmits at least a part of light to be incident on the eye when the reflector is disposed in front of the eye of the operator. The sensor senses a working state of the operator. The controller controls the light source based on the working state in a manner that a luminance of the light emitted from the light source is reduced when the working state indicates that the operator is at work.

### CROSS-REFERENCE TO RELATED APPLICATIONS

This application is based upon and claims the benefit of priority from Japanese Patent Application No. 2013-222642, filed on Oct. 25, 2013; the entire contents of which are incorporated herein by reference.

### FIELD

Embodiments described herein relate generally to a display device.

### BACKGROUND

To increase work efficiency, it is desirable to provide an operator with information relating to the work without the point that is viewed by the operator being shifted from the position of the work. AR (Augmented Reality) is a method for presenting information of real space. It is desirable to realize a display device in which the information relating to the work is easy to view and the efficiency of the work is higher.

### BRIEF DESCRIPTION OF THE DRAWINGS

FIG. 1 is a schematic view showing a display device according to a first embodiment;

FIGS. 2A-2D are graphical views showing operations of the display device according to the first embodiment;

FIGS. 3A-3B are graphical views showing operations of the display device according to the first embodiment;

FIGS. 4A-4B are graphical views showing operations of the display device according to the second embodiment; and

FIG. 5 is a schematic view showing the display device according to an embodiment.

### DETAILED DESCRIPTION

According to one embodiment, a display device includes a light emitting unit, a reflective unit, a sensor, and a controller. The light source emits light including an image information relating to operation to be performed by an operator. The reflector reflects at least a part of the light emitted from the light source toward an eye of the operator and transmits at least a part of light to be incident on the eye when the reflector is disposed in front of the eye of the operator. The sensor senses a working state of the operator. The controller controls the light source based on the working state in a manner that a luminance of the light emitted from the light source is reduced when the working state indicates that the operator is at work.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

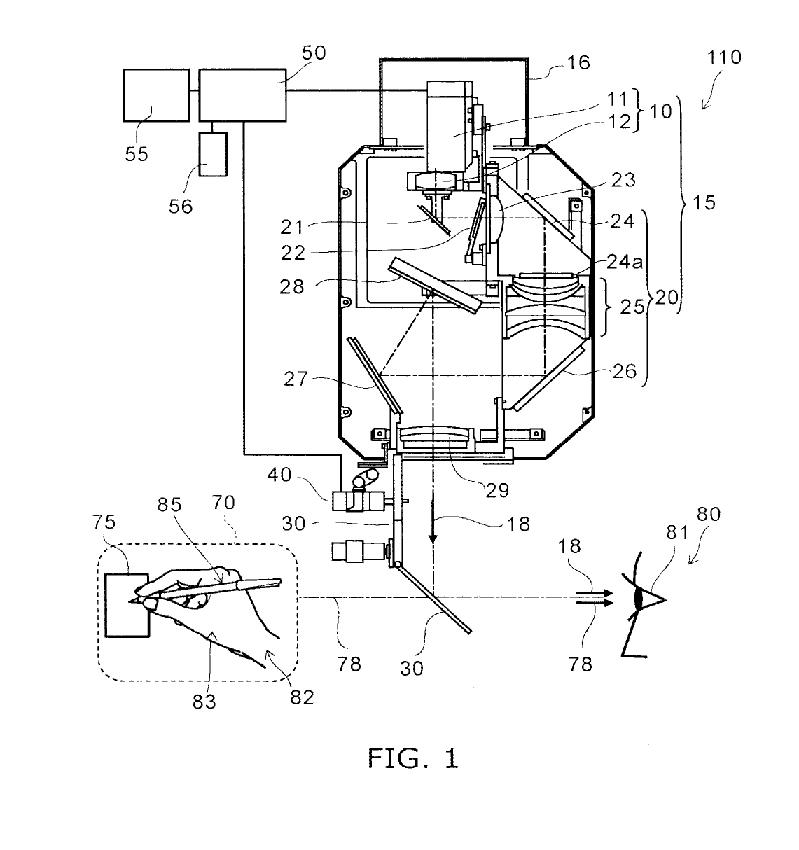

FIG. 1 is a schematic view illustrating a display device according to a first embodiment.

As shown in FIG. 1, the display device 110 according to the embodiment includes a light emitting unit 15, a reflective unit 30, a sensor 40, and a controller 50.

The display device 110 is used by an operator 80. The operator 80 performs work in a work space 70. For example, the operator 80 performs processing of a work object 75. In the embodiment, for example, the work is performed within reach. The work may be, for example, the disassembly, assembly, operation, etc., of members. The work may be, for example, precision work such as surgical work performed in physics and chemistry fields, medical fields, etc. In the embodiment, the content of the work is arbitrary. For example, the operator 80 holds a work tool 85 in a hand 83 of the body 82 of the operator 80. The operator 80 uses the work tool 85 to process the work object 75. Writing work is assumed for the work shown in FIG. 1. Examples of the work are described below.

The light emitting unit 15 emits light flux 18 including an image. The image includes information relating to the work performed by the operator 80 in the work space 70. For example, the image includes procedures for the work, etc. The image includes marks indicating the position of the work object 75, etc.

In the example, the light emitting unit 15 includes an image generation unit 10 and an image projection unit 20. The image generation unit 10 produces the light flux 18. The image generation unit 10 includes, for example, a light source unit 11 and an image formation unit 12. The light source unit includes, for example, a semiconductor light emitting element, etc. The image formation unit 12 includes, for example, a liquid crystal display element, a MEMS display element, etc. In the embodiment, the light source unit 11 and the image formation unit 12 are arbitrary.

In the example, the image projection unit 20 includes a first reflecting element 21, a screen 22, a first lens unit 23 (a light-concentrating unit), a second reflecting element 24, an aperture stop 24a, a second lens unit 25, a third reflecting element 26, a fourth reflecting element 27, a fifth reflecting element 28, and a third lens unit 29. Portions of these components are arranged in the order recited above along the optical path of the light flux 18. For example, the aperture stop 24a is disposed at a position separated from the second lens unit 25 according to the focal distance of the second lens unit 25. For example, the distance between the aperture stop 24a and the second lens unit 25 is substantially equal to the focal distance of the second lens unit 25.

The screen 22 transmits at least a portion of the light flux 18. For example, the distance between the screen 22 and the first lens unit 23 is substantially equal to the focal distance of the first lens unit 23. The distance along the optical path of the light flux 18 between the screen 22 and the first lens unit 23 is not less than 0.9 times and not more than 1.1 times the focal distance.

The image generation unit 10 and the image projection unit 20 are contained, for example, inside a housing 16. The housing 16 may be included in, for example, the light emitting unit 15.

The reflective unit 30 is light-reflective and light-transmissive. The reflective unit 30 is disposed, for example, between the work space 70 and an eye 81 of the operator 80. The reflective unit 30 reflects the light flux 18 emitted from the light emitting unit 15 toward the eye 81 of the operator 80. The reflective unit 30 transmits light 78 from the work space 70 to be incident on the eye 81.

For example, the image projection unit 20 projects the light flux 18 produced by the image generation unit 10 toward the reflective unit 30. The light flux 18 that is projected by the reflective unit 30 is reflected by the reflective unit 30 to be incident on the eye 81. The reflective unit 30 includes, for example, a combiner.

The operator 80 can view both the image (the display information) included in the light flux 18 and the image (the light) of the work object 75 existing in the work space 70.

In the example, the reflective unit 30 is fixed by a holder 31 extending from the housing 16.

The sensor 40 senses the working state of the operator 80. The sensor 40 senses the working state by, for example, sensing the state of the operator 80. The sensor 40 senses the working state by sensing the state of the work object 75. The sensor 40 may sense the working state by, for example, sensing the state of the operator 80 and the state of the work object 75.

The controller 50 controls the luminance of the light flux 18. The control is performed by, for example, controlling the light emitting unit 15. For example, the controller 50 controls the luminance of the light flux 18 by controlling the image generation unit 10. In the embodiment, the controller 50 may control the luminance of the light flux 18 incident on the eye 81 by controlling optical characteristics (e.g., the reflectance, etc.) of the reflective unit 30.

The display device 110 may further include, for example, memory 55. The memory 55 stores information relating to the luminance of the light flux 18. The memory 55 stores, for example, information relating to the control of the light flux 18 by the controller 50. The memory 55 may store, for example, information relating to the sensing result of the working state by the sensor 40.

The display device 110 may further include, for example, a timer 56. The timer 56 measures the elapse of time. The timer 56 may be included in the controller 50.

Operations of the memory 55 and the timer 56 are described below.

An example of operations of the display device 110 will now be described.

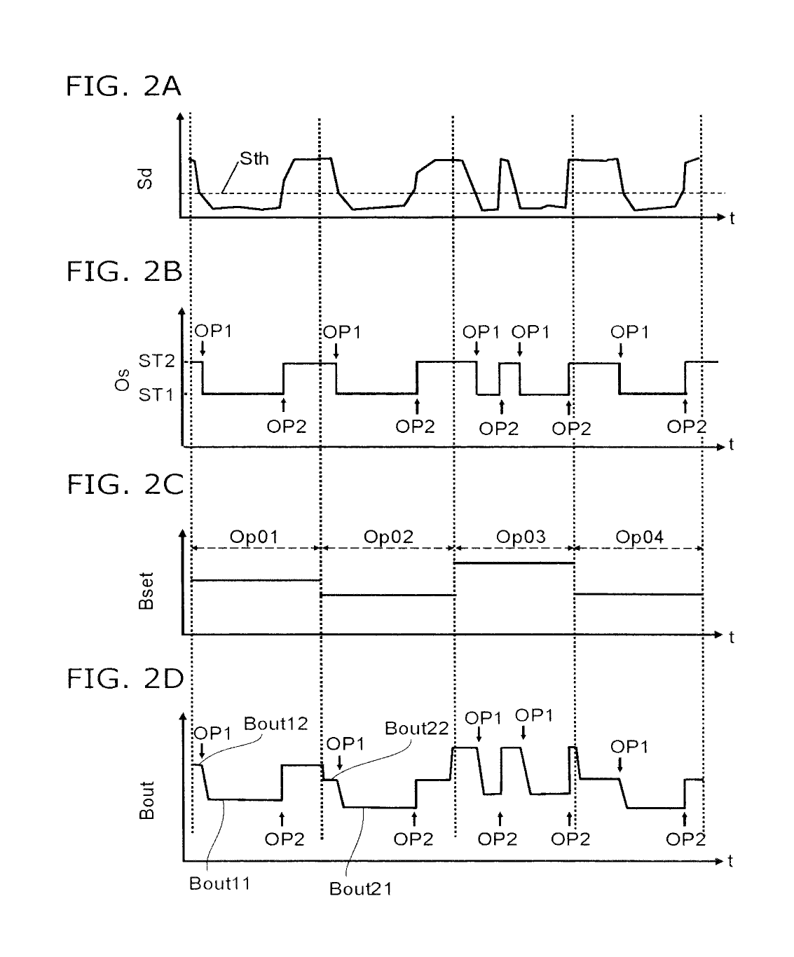

FIG. 2A to FIG. 2D are graphical views illustrating operations of the display device according to the first embodiment.

In these drawings, the horizontal axis is time t. FIG. 2A illustrates a detection signal Sd sensed by the sensor 40. FIG. 2B illustrates the determination result of a working state Os performed based on the sensing result of the sensor 40. FIG. 2C illustrates a setting (a set luminance Bset) of the luminance of the light flux 18. FIG. 2D illustrates a luminance (a post-control luminance Bout) of the light flux 18 controlled by the controller 50.

As shown in FIG. 2C, the work of the example includes a first process Op01, a second process Op02, a third process Op03, a fourth process Op04, etc. The processes are performed, for example, sequentially.

The set luminance Bset illustrated in FIG. 2C is, for example, the luminance of the light flux 18 when the operator 80 simply views the image. For example, in the case where the operator 80 views the image when not performing the work, the operator 80 views the image without viewing the work object 75 when working. Images of different display content are displayed according to the processes. The images according to the processes each have an appropriate luminance according to the process. The operator 80 can easily view the image by displaying the image at the appropriate luminance. In the example illustrated in FIG. 2C, the set luminance is modified between the processes.

As illustrated in FIG. 2A, the detection signal Sd of the sensor 40 changes over time. For example, the distance between the work object 75 and the work tool 85 used by the operator 80 decreases when the operator 80 performs the work. The detection signal Sd is the sensing result when sensing the distance. In the example, for example, the distance recited above decreases as the value of the detection signal Sd decreases. In other words, a small detection signal Sd corresponds to working. A large detection signal Sd corresponds to not working.

As illustrated in FIG. 2A, a threshold Sth is set for the detection signal Sd. For example, the threshold Sth can be preset. The threshold Sth may be modified according to the processes. For example, the determination between working and not working can be performed by comparing the detection signal Sd and the threshold Sth.

FIG. 2B illustrates the determination result of the working state Os. The state is determined to be a working state ST1 when the detection signal Sd is smaller than the threshold Sth. The state is determined to be a not-working state ST2 when the detection signal Sd is not less than the threshold Sth.

For example, the transition from the not-working state ST2 to the working state ST1 corresponds to a work start OP1. The transition from the working state ST1 to the not-working state ST2 corresponds to a not-work start OP2. The not-work start OP2 corresponds to the end of the work, the discontinuation of the work, etc.

In the embodiment, the controller 50 modifies the luminance of the light flux 18 in the working state ST1 and the not-working state ST2.

As shown in FIG. 2D, the controller 50 sets the luminance of the light flux 18 when the operator 80 is performing the work (the working state ST1) to be lower than the luminance of the light flux 18 when the operator 80 is not performing the work (the not-working state ST2). The controller 50 sets the luminance of the light flux 18 to be a first value when the operator 80 is performing the work (the working state ST1). The controller 50 sets the light flux 18 to be a second value when the operator 80 is not performing the work (the not-working state ST2). The first value is lower than the second value.

For example, the controller 50 implements a first operation of reducing the luminance of the light flux at the transition (the work start OP1) from the state in which the operator 80 is not performing the work to the state in which the operator 80 is performing the work. The controller 50 implements a second operation of increasing the luminance of the light flux 18 at the transition (the not-work start OP2) from the state in which the operator 80 is performing the work to the state in which the operator 80 is not performing the work. The controller 50 implements at least one of the first operation and the second operation.

In the embodiment, when the operator 80 is not performing the work, the light flux 18 is set to the luminance (the set luminance Bset) that is appropriate when not performing the work. When the operator 80 starts to work and is working, the luminance of the light flux 18 is set to a value (the post-control luminance Bout) lower than the set luminance Bset. Thereby, the operator 80 has higher visibility of the work object 75 when working. A low visibility of the work object 75 due to an excessively bright image when working is suppressed.

Generally, in a superimposed-type image display device for assisting work, the image is viewed with both eyes. For example, when viewing the image of the work object (the work object 75) and the display image with both eyes, in the case where the position of the work object matches the position (e.g., the virtual image position) of the display image, it is difficult to separately perceive the work object and the display image. In other words, the work object is difficult to view; and the display image is difficult to view.

On the other hand, when the position of the work object and the position of the display image are shifted from each other, it is markedly difficult to simultaneously perceive the work object and the display image. Further, the display image undesirably blocks the work object; and the perception of the work object is markedly obstructed.

Thus, for example, in a binocular AR display device, it is extremely difficult to display the work object and the display image superimposed without degraded visibility (i.e., the effects on the operationability) of the work object.

The inventors of the application performed experiments using a monocular display device for the work. In the experiments, a head-up display (HUD) was used as the monocular display device. The inventor of the application discovered from the results of the experiments that it is possible to clearly perceive the work object without the display image blocking the work object even when the display image is displayed to be superimposed onto the work object. Similar results are obtained even when using a head mounted display (HMD) as the monocular display device.

In the case of the monocular display device, the display image is projected toward only one eye (the eye 81) of the viewer (the operator 80). The image (the image of the work object) of the work space 70 in which the work is performed is incident on both eyes of the viewer via a combiner (the reflective unit 30). In the binocular display device, it is difficult to perceive only one of the image of the work object and the display image. Conversely, in the case of the monocular display device, when the operator 80 starts to perform the work, the operator 80 uses the hand 83, etc., to initiate the work in the work space 70. It was found that at this time, the operator 80 mainly perceives the work object even though the work object and the display image are incident on the eye 81. It was found that when the operator 80 starts to perform the work, the display image substantially is no longer perceived.

It is considered that this is because the degree of the perception of the work object space 70 increases and the degree of the perception of the display image decreases when a human concentrates visual attention on the work object space 70. In other words, it is considered that, for example, a so-called perceptual alternation of perceptual psychology occurs.

Such characteristics are related to the visual characteristics of a human and the characteristics of the processing of the visual information in the brain.

An easily-viewable display can be provided to the operator 80 by utilizing such a phenomenon. In the embodiment, the degree of the concentration of the attention to the work space 70 by the operator 80 is increased. Thereby, a more easily-viewable display can be realized. The embodiment controls the luminance of the light flux 18 emitted from the display device according to the status of the work. In the embodiment, when working, it is possible to clearly view the work space; and the work efficiency can be increased. On the other hand, the display image is easy to view when not working. For example, when not working, the operator 80 can more reliably acquire the information relating to the work from the display image. Thereby, the work efficiency increases further.

For example, there is a method for a head-up display in which the luminance of the display image is controlled according to the external light luminance. Such a method does not control the luminance according to the performance/non-performance of the work. Therefore, the method is insufficient to make an easily-viewable display when working.

In the embodiment, the working state is sensed by the sensor 40; and the luminance is controlled by the controller 50 based on the result. Thereby, an easily-viewable display device for work can be provided.

In the embodiment, for example, blocks are assembled in the work space 70 as the work. For example, the block parts are disposed in the work space 70. In this state, the display image includes a drawing of the assembly method of the blocks, etc. In the embodiment, the content of the work and the display image are arbitrary.

As in the example, the work may include, for example, the first process Op01 and the second process Op02. In such a case, the luminance (Bout) to which the light flux 18 is set may be different between the processes.

For example, the controller 50 sets the luminance of the light flux 18 to a first process working luminance Bout11 when the operator 80 is performing the work of the first process Op01. Then, the controller 50 sets the luminance of the light flux 18 to a first process not-working luminance Bout12 when the operator 80 is not performing the work of the first process Op01. The first process working luminance Bout11 is lower than the first process not-working luminance Bout12.

For example, the controller 50 sets the luminance of the light flux 18 to a second process working luminance Bout21 when the operator 80 is performing the work of the second process Op02. Then, the controller 50 sets the luminance of the light flux 18 to a second process not-working luminance Bout22 when the operator 80 is not performing the work of the second process Op02. The second process working luminance Bout21 is lower than the second process not-working luminance Bout22.

The luminance of the light flux 18 may be different between the multiple processes. For example, the second process not-working luminance Bout22 is different from the first process not-working luminance Bout12. For example, the second process working luminance Bout21 is different from the first process working luminance Bout11.

The memory 55 can store the first process working luminance Bout11, the first process not-working luminance Bout12, the second process working luminance Bout21, and the second process not-working luminance Bout22 recited above.

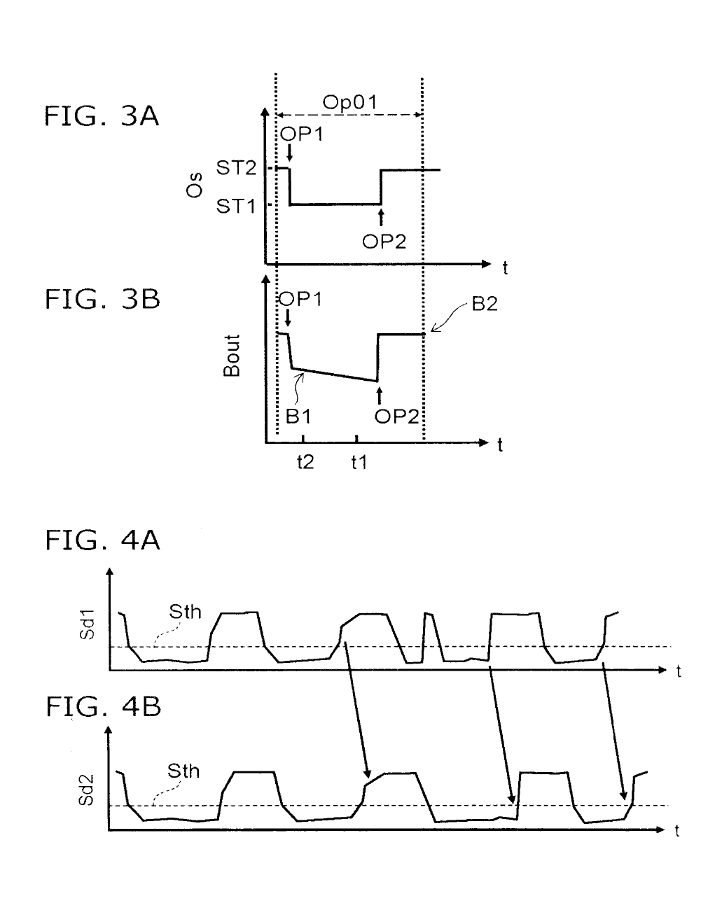

FIG. 3A and FIG. 3B are graphical views illustrating operations of the display device according to the first embodiment.

In these drawings, the horizontal axis is the time t. FIG. 3A illustrates the determination result of the working state Os performed based on the sensing result of the sensor 40. FIG. 3B illustrates the luminance (the post-control luminance Bout) of the light flux 18 controlled by the controller 50.

In the example, the operation of the first process Op01 is illustrated.

As shown in FIG. 3A and FIG. 3B, in the example as well, the controller 50 sets the luminance of the light flux 18 when the operator 80 is performing the work (the working state ST1) to be lower than the luminance of the light flux 18 when the operator 80 is not performing the work (the not-working state ST2).

When it is determined that the operator 80 is not performing the work, the controller 50 sets the luminance of the light flux 18 to a preset not-working luminance B2. Then, the light flux 18 that has the not-working luminance B2 is projected toward the eye 81. When it is determined that the operator 80 is performing the work, the controller 50 sets the luminance of the light flux 18 to a working luminance B1. The working luminance B1 is lower than the not-working luminance B2. The working luminance B1 is presettable by the operator 80.

In the case where the memory 55 is provided, the memory 55 may store information relating to the luminance of the light flux 18 of previous work performed by the operator 80. In such a case, the controller 50 may determine the working luminance B1 based on the information relating to the luminance of the light flux 18 of the previous work stored in the memory 55.

Visual attention is a factor relating to perceptual alternation. The dependence of visual attention on personal characteristics is large. In the work, continuous multiple processes are provided. The visual attention changes due to the duration of the work. The visual attention changes according to the work object.

In the embodiment, the luminance of the light flux 18 may be changed not only for the performance/non-performance of the work but also for changes of the duration of the work and the work object.

For example, as shown in FIG. 3A and FIG. 3B, the luminance may be changed in the working state ST1. In other words, the controller 50 reduces the luminance of the light flux 18 at the transition (the work start OP1) from the state (the not-working state ST2) in which the operator 80 is not performing the work to the state (the working state ST1) in which the operator 80 is performing the work. Further, the luminance of the light flux 18 at a first time t1 is lower than the luminance of the light flux 18 at a second time t2, where the elapsed time from the transition is long at the first time t1, and the elapsed time from the transition at the second time t2 is shorter than at the first time t1.

The sense of sight of a human has a characteristic of adapting to luminance. Therefore, a more easily-viewable display can be provided by reducing the luminance as time elapses.

As illustrated in FIG. 3B, the controller 50 may continuously change the luminance of the light flux 18 for at least a portion between the second time t2 and the first time t1. The controller 50 may change the luminance of the light flux 18 in a step configuration for at least a portion between the second time t2 and the first time t1.

For example, the timer 56 is used to measure the elapse of time recited above.

For example, the operator 80 sets the luminance of the light flux 18 to a favorable value. The value that is set is stored in the memory 55. Further, the operator 80 sets the value of the luminance determined to be optimal when working. The value of the luminance is stored by the memory 55. The value of the luminance determined to be optimal when working is stored in the memory 55 with the elapsed time. For example, values of the optimal luminance for the work times are stored sequentially in the memory 55.

When performing the work, the value of the luminance that corresponds to the time measurement point is extracted from the memory 55 according to the elapsed time and the determination of the work start. Based on the value, the controller 50 controls the light emitting unit 15 such that the luminance of the light flux 18 is set to a luminance corresponding to the elapsed time.

For example, the luminance of the display is reduced according to the change of attention to the work object with the elapse of work time. Thereby, it is possible to maintain the work efficiency.

### Second Embodiment

In the embodiment, the luminance of the light flux 18 is modified according to the progress of the work. For example, in the case where the work includes multiple processes, the luminance of the light flux 18 is modified according to the progress of the multiple processes. The work object (the state of the work object) may be different between the multiple processes. The work content may be different between the multiple processes. In such cases, the attention allocated to the work object can be controlled by appropriately modifying the luminance of the light flux 18 according to the dependence of the attention of the operator 80.

FIG. 4A and FIG. 4B are graphical views illustrating operations of the display device according to the second embodiment.

FIG. 4A illustrates a detection signal Sd1 of work that was implemented previously. For example, the detection signal Sd1 is stored in the memory 55. FIG. 4B illustrates a detection signal Sd2 that is sensed by the sensor 40 in the work that is implemented currently.

As shown in FIG. 4A and FIG. 4B, in the example, the pattern of the detection signal Sd2 of the work that is implemented currently is delayed from the pattern of the detection signal Sd1 of the work that was implemented previously. The state of the work that is implemented currently can be determined from the detection signal Sd2.

The pattern of the detection signal obtained by the sensor 40 changes uniquely according to the work object, the work content, etc. By recording the peculiarities, the status of the work being implemented can be determined.

The appropriate values of the luminance of the light flux 18 corresponding to the work status are stored, for example, in the memory 55. Based on the sensed work status and the values of the appropriate luminance corresponding to the work status, the controller 50 controls, according to the sensed work status (the detection signal Sd2), the light flux 18 to have a luminance according to the stored values.

The appropriate values of the luminance of the light flux 18 corresponding to the work status may be determined based on information relating to the luminance of work implemented previously. For example, values preferred by the operator 80 in the actual work of the operator 80 may be monitored and stored in the memory 55.

For example, the pattern of the detection signal Sd1 stored in the memory 55 is compared to the detection signal Sd2 sensed in the work that is actually implemented. For such patterns, there are cases where the time at which the pattern is expressed differs (shifts) according to the working state. In such a case, the work efficiency can be increased by producing the light flux 18 from a stored value of the luminance at a suitable timing.

For example, the memory 55 may store information relating to the luminance of the light flux 18 of the work of the first process Op01 and the second process Op02 previously performed by the operator 80. In such a case, the controller 50 may determine at least one of the first process working luminance Bout11 and the second process working luminance Bout21 based on the information relating to the luminance of the light flux 18 of the previous work stored in the memory 55. The controller 50 may determine at least one of the first process not-working luminance Bout12 and the second process not-working luminance Bout22 based on the information relating to the luminance of the light flux 18 of the previous work stored in the memory 55.

The luminance of the light flux 18 may be controlled by a method for temporal control and a method for controlling according to the status. In the embodiment, the luminance of the light flux 18 may be controlled by both of these methods.

For example, the luminance may be changed according to the elapse of time after producing the light flux 18 to have prescribed luminance at prescribed times according to the performance/non-performance of the work and the work status. For example, the control of the luminance is performed according to the change of the work object and the change of the work content. Also, the control of the luminance is performed according to the progress of the work. For example, the work efficiency can be increased for work having a long work time.

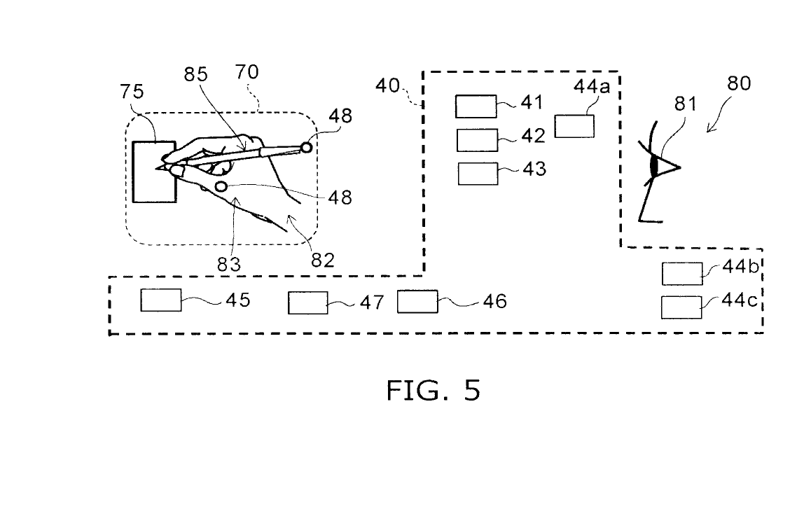

FIG. 5 is a schematic view illustrating the display device according to an embodiment.

As shown in FIG. 5, the sensor 40 may include a work space optical information acquisition unit 41. The work space optical information acquisition unit 41 acquires the optical information of the work space 70. The work space optical information acquisition unit 41 may include, for example, at least one of an imaging element, a camera, and a light detector. The optical information of the work space 70 includes, for example, at least one of the luminance of the work space 70, the distribution of the luminance of the work space 70, and the luminance at multiple positions of the work space 70.

The sensor 40 may include an image acquisition unit 42. The image acquisition unit 42 acquires image information of the work space 70. The image acquisition unit 42 may include, for example, an imaging element, a camera, etc.

At least one of the sensor 40 and the controller 50 may perform pattern recognition of the work space 70 based on the image information acquired by the image acquisition unit 42. At least one of the sensor 40 and the controller 50 determines whether or not the operator 80 is performing the work based on the result of the pattern recognition. The control of the controller 50 is performed based on the result of the determination.

The sensor 40 may include a luminance change acquisition unit 43. The luminance change acquisition unit 43 acquires a luminance change of the work space 70. For example, the hand 83 of the operator 80 approaches the position of the work object 75 when the operator 80 starts the work. Therefore, the luminance of the position of the work object 75 changes. The luminance change acquisition unit 43 acquires information relating to the change of the luminance. An imaging element, a camera, a light detector, or the like is used as the luminance change acquisition unit 43.

The sensor 40 may sense the state of the operator 80. For example, the sensor 40 may include at least one of a line of sight sensor 44a, a neural signal acquisition unit 44b, and an operator position change information acquisition unit 44c. The line of sight sensor 44a senses the line of sight of the operator 80. The neural signal acquisition unit 44b acquires the neural signal of the operator 80. The operator position change information acquisition unit 44c acquires information relating to the change of the position of the operator 80.

The sensor 40 may include a work object information acquisition unit 45. The work object information acquisition unit 45 acquires information relating to the change of the work object 75 of the work. The work object information acquisition unit 45 acquires information relating to, for example, at least one of a change of the configuration of the work object 75, a change of the temperature of the work object 75, a change of the color of the work object 75, and a change of the mass of the work object 75.

The sensor 40 may acquire information relating to the relative relationship between the work object 75 and the operator 80. The sensor 40 may include a relative position information acquisition unit 46. The relative position information acquisition unit 46 acquires, for example, at least one of information relating to the relative positions between the work object 75 of the work and the body 82 of the operator 80 and information relating to the relative positions between the work object 75 and the work tool 85 used by the operator 80.

The sensor 40 may include an electromagnetic information sensor 47. The electromagnetic information sensor 47 electromagnetically senses at least one of the hand 83 of the operator 80 and the work tool 85 used by the operator 80.

The display device 110 may further include a marker unit 48 for sensing the work. The marker unit 48 is adhered to, for example, at least one of the hand 83 of the operator 80 and the work tool 85 used by the operator 80. In such a case, the sensor 40 senses the marker unit 48 based on, for example, at least one of an optical characteristic, a magnetic property, and an electrical characteristic. Then, the sensor 40 senses the working state of the operator 80 based on the sensing result.

In the embodiment, for example, an imaging element is used as the work space optical information acquisition unit 41.

When there is no initiation of work by the operator 80 in the work space 70, the luminance (the luminance) of the work space 70 is constant. When fluctuation of the luminance occurs, it is determined that work is being performed. For example, work may be determined to be performed when continuous luminance fluctuation is sustained for a predetermined time. The predetermined time is, for example, not less than 1 second and not more than 5 seconds, e.g., 5 seconds.

In the case where the output from the imaging element is extracted as an image, the working state (e.g., the performance/non-performance of the work) may be determined by comparing the image and pre-provided information.

For example, edges may be sensed from the image obtained from the imaging element; and a change of the edges may be determined to be a change of the performance/non-performance of the work.

The work object (the work object 75) may be known. In such a case, for example, the three-dimensional configuration of the drawing of the work object may be provided beforehand to the sensor 40. The sensor 40 (or the controller 50) may sense the performance/non-performance of the work by sensing the change of the work object as the work progresses.

For example, there may be a photograph, etc., corresponding to the work object. In such a case, matching between the configuration of the work object and the photograph that is provided is evaluated. Thereby, the working state (e.g., the performance/non-performance of the work) can be determined. Other than the configuration of the work object, the work object and the work space 70 may be determined simultaneously. As the information relating to the work space 70, the working state (e.g., the performance/non-performance of the work) may be determined based on at least one of the landscape of the work space 70, the color of the work space 70, the light distribution state of the work space, etc.

In the embodiment, the marker unit 48 (e.g., an optical marker) may be disposed on at least one of a part used to form the work object, the hand 83 of the operator 80, and the work tool 85 of the operator 80. Also, the performance/non-performance of the work and the progress status of the work may be ascertained by sensing the marker unit 48 in the image.

In the case where the electromagnetic information sensor 47 is provided in the sensor 40, for example, a RFID is disposed in at least one of, for example, a part used to form the work object, the hand 83 of the operator 80, and the work tool 85 used by the operator 80. The existence of the RFID or the position of the RFID inside the prescribed space is sensed. Thereby, the working state (e.g., the performance/non-performance of the work) and the progress status of the work can be ascertained.

The operator 80 may hold a positional information transmission source for a data glove. Thereby, the working state (e.g., the performance/non-performance of the work) and the progress status of the work can be ascertained.

A sensing unit may be provided at the operator 80.

For example, in the case where the sensor 40 includes the line of sight sensor 44a, the position that is paid attention to inside the work space 70 of the operator 80 is known. Thereby, the working state (e.g., the performance/non-performance of the work) and the progress status of the work can be ascertained.

For example, in the case where the sensor 40 includes the neural signal acquisition unit 44b, a signal relating to, for example, at least one of the brain waves and cerebral blood flow of the operator 80 is acquired. For example, the work status of the operator 80 can be determined by measuring the brain activity of the operator 80 by MR.

In the case where the work object has a distinctive movement when working, the working state (e.g., the performance/non-performance of the work) and the progress status of the work may be ascertained by obtaining information relating to the distinctive portion of the movement.

The operator 80 may actively switch between performance/non-performance of the work. For example, the state of a switch or the like used for the switching may be sensed. At least one of the voice, blinking, and body movement (stepping, etc.) of the operator 80 may be sensed. The sensing may be performed using movement of muscles (including the lingual muscle, etc.) and the like that accompany such behavior of the operator 80.

In the case where the operator 80 is in a movable state, the position of at least a portion of the body 82 of the operator 80 may be sensed. For example, and the seat of the operator 80 may be movable. For example, the operator 80 may be on a movable vehicle. For example, the operator 80 may be walking. The operator 80 is sensed in the space in which the operator 80 moves. The objects that exist inside the space in which the operator 80 moves are sensed.

For example, the work object may exist on a belt conveyor. For example, an operator that is on a belt conveyor may move through the work object. For example, the operator 80 may move through a factory. For example, the operator 80 may move in a construction site.

For example, known information that is input beforehand may be used as the determination of the work status. The display device 110 according to the embodiment may be connected to a network. The memory 55 may be provided on the network. For example, the display device 110 is linked to a database (e.g., the memory 55) on the network. In such a case, the information in the database may be used when comparing.

In the embodiment, an image having a luminance that is appropriate for the working state, the work content, or the elapsed work time can be provided. Thereby, a display device for work that makes it easy to work can be provided.

According to the embodiments, an easily-viewable display device for work can be provided.

Hereinabove, embodiments of the invention are described with reference to specific examples. However, the invention is not limited to these specific examples. For example, one skilled in the art may similarly practice the invention by appropriately selecting specific configurations of components included in the display device such as the light emitting unit, the image generation unit, the image projection unit, the screen, the aperture stop, the reflecting element, the lens unit, the reflective unit, the sensor, the controller, the memory, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all display devices practicable by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device, comprising:
a light source that emits light including an image information relating to operation to be performed by an operator;
a reflector that reflects at least a part of the light emitted from the light source toward an eye of the operator and transmits at least a part of light to be incident on the eye when the reflector is disposed in front of the eye of the operator;
a sensor that senses a working state of the operator; and
a controller that controls the light source based on the working state in a manner that a luminance of the light emitted from the light source is reduced when the working state indicates that the operator is at work.

2. The device according to claim 1, wherein the controller controls the light source based on the working state in a manner that the luminance of the light is a first value when the working state indicates that the operator is at work and the luminance of the light is a second value when the working state indicates that the operator is not at work, the first value being lower than the second value.

3. The device according to claim 1, wherein
the controller implements at least one of a first operation and a second operation,
the first operation including reducing the luminance of the light when the working state changes from not at work to at work, and
the second operation including increasing the luminance of the light when the working state changes from at work to not at work.

4. The device according to claim 1, wherein the light source includes:
a display that generates the light; and
an projector that projects the light induced by the display toward the reflector.

5. The device according to claim 1, wherein the sensor includes an imager to acquire optical information and the sensor senses the working state based on the optical information.

6. The device according to claim 1, wherein the sensor senses a change in luminance and senses the working state based on the change.

7. The device according to claim 1, wherein the sensor senses at least one of a line of sight of the operator, a neural signal of the operator, and a change in position of the operator.

8. The device according to claim 1, wherein the sensor acquires information relating to a change of a work object of the work.

9. The device according to claim 1, wherein the sensor senses at least one of:
information relating to relative positions between a work object and the operator; and
information relating to relative positions between the work object and a work tool used by the operator.

10. The device according to claim 1, wherein the sensor electromagnetically senses at least one of a hand of the operator and a work tool used by the operator.

11. The device according to claim 1, wherein the sensor senses a marker having magnetic property or electronic property.

12. The device according to claim 1, wherein
the controller reduces the luminance of the light when transitioning from a state of the operator not performing the work to a state of the operator performing the work, and
the controller sets a luminance of the light at a first time to be lower than a luminance of the light at a second time, a first elapsed time from the transition at the first time being longer than a second elapsed time from the transition at the second time.

13. The device according to claim 2, wherein
the first value is settable by the operator.

14. The device according to claim 1, further comprising a memory to store information relating to a luminance of the light in previous work,
wherein the controller controls the light based on the stored luminance of the light in the previous work.

15. The device according to claim 1, wherein
the sensor senses a kind of operation to be performed by the operator,
the controller controls the light source according to the kind of operation, to which the luminance of the light corresponding is preliminary determined.

16. The device according to claim 14, wherein the memory stores the information relating the luminance of the light in the previous work with respect to a kind of operation to be performed by the operator.

17. The device according to claim 1, wherein
the operator performs a first process and a second process, the second process is performed after the first process,
the controller sets the luminance of the light to a first working luminance when the working state is at work in the first process,
the controller sets the luminance of the light to a first not-working luminance when t the working state is not at work in the first process,
the first working luminance is lower than the first not-working luminance,
the controller sets the luminance of the light to a second working luminance when the working state is at work in the second process,
the controller sets the luminance of the light to a second not-working luminance when the working state is not at working in the second process,
the second working luminance is lower than the second not-working luminance,
the second not-working luminance is different from the first not-working luminance,
the first necessary time is predetermined and necessary for the first process,
the controller the light source so that the light source starts to change the luminance of the light between the second working luminance and the second not-working luminance in the second process based on a time elapsed from a time of a transition from not at working in the first process to at working in the first process.

18. The device according to claim 1, wherein
the light source includes a light-concentrating unit and an aperture, the aperture transmitting at least a portion of the light, the light-concentrating unit concentrating the light; and
a distance along an optical path of the light between the aperture and the light-concentrating unit is not less than 0.9 times and not more than 1.1 times a focal distance of the light-concentrating unit.

19. The device according to claim 1, wherein the sensor includes an electromagnetic information sensor to electromagnetically sense a hand of the operator.

20. The device according to claim 1, wherein the sensor includes an electromagnetic information sensor configured to electromagnetically sense a work tool used by the operator.
